(19) United States
(12) Patent Application Publication
(10) Pub. No.: US 2007/0071214 A1
(43) Pub. Date: Mar. 29, 2007

(54) METHOD FOR DETECTING A CPE ALERT SIGNAL OF A TELECOMMUNICATION SYSTEM BY UTILIZING AN ENERGY RATIO

(76) Inventors: Ching-Hsun Chen, Hsin-Chu City (TW); Shan-Jen Hsiao, Tainan Hsien (TW); Chien-Hsing Lin, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/162,603

(22) Filed: Sep. 16, 2005

(51) Int. Cl. H04M 3/42

(52) U.S. Cl. 379/215.01

(57) ABSTRACT

A method for detecting a CPE alert signal of a telecommunication system. The method includes: detecting a first signal energy at a first frequency; detecting a second signal energy at a second frequency; comparing a total received signal energy with a summation of at least the first signal energy and the second signal energy to generate a comparison result; and enabling a first detecting procedure or a second detecting procedure for detecting the CPE alert signal according to a comparison result.

### BACKGROUND OF THE INVENTION

1. Field of the Invention

The present invention relates to signal detection in a telecommunication system, and more particularly to a method for an adaptive detection of a CPE alert signal by utilizing an energy ratio.

2. Description of the Prior Art

In addition to conventional telecommunication systems, a call waiting system is used in the U.S.A., which has a standard TIA/EIA-777. These TIA (Telecommunications Industry Association) standards describe the requirements for Caller ID capable Customer Premises Equipment (CPE) under both on-hook (type-1) and off-hook (type-2) modes. Please refer to FIG. 1, which is a flowchart illustrating operation of a prior art call waiting mechanism. The telephone service provider 10 is used to provide communication services for a plurality of CPE's 12, 14, 16. Assume that the CPE 12 is currently communicating with the CPE 14 on line 1 through the telephone service provider 10. If the CPE 16 wants to communicate with the CPE 14 on line 2, the telephone service provider 10 will activate the call waiting mechanism for notifying the CPE 14. Firstly, the telephone service provider 10 temporarily blocks the speech sounds outputted from the CPE 12 from reaching the CPE 14, and sends a CPE alert signal (CAS) to the CPE 14 during this period. Please refer to FIG. 2, which is a diagram illustrating the composition of the CAS signal. As shown in FIG. 2, the CAS signal is composed of two DTMF (Dual Tone Multi-Frequency) signals S₁ and S₂, where one DTMF signal S₁ has a frequency of about 2130 Hz, and the other DTMF signal S₂ has a frequency of approximately 2750 Hz.

After detecting the CAS signal transmitted from the telephone company 10, the CPE 14 itself stops outputting speech sounds automatically for a short period of time, and transmits an ACK signal to the telephone service provider 10 in response to the CAS signal. After receiving the ACK signal outputted from the CPE 14, the telephone service provider 10 starts transmitting information related to the CPE 16 (e.g., the phone number of the CPE 16) to the CPE 14. Once the CPE 14 successfully receives the incoming information related to the CPE 16 the call waiting operation is finished.

Please note that during the process of transmitting the CAS signal to the CPE 14, the CPE 14 continues to output speech sounds. However, both the CAS signal and the speech sounds share the same frequency band. Therefore, due to the outgoing speech sounds, the CAS signal suffers from unwanted interference more seriously. As a result, the interference imposed upon the CAS signal makes the prior art call waiting mechanism fail to correctly detect the CAS signal. Therefore, how to correctly detect the CAS signal becomes an important issue for a telecommunication system.

### SUMMARY OF THE INVENTION

It is therefore one of the objectives of the claimed invention to provide an adaptive method for detection of a CPE alert signal of a telecommunication system by utilizing an energy ratio, to solve the above problem.

The claimed invention discloses a method for detecting a CPE alert signal of a telecommunication system. The method comprises detecting a first signal energy at a first frequency; detecting a second signal energy at a second frequency; comparing a total received signal energy with a summation of at least the first signal energy and the second signal energy to generate a comparison result; and enabling a first detecting procedure or a second detecting procedure for detecting the CPE alert signal according to a comparison result.

This present invention can adopt different CAS detection criteria to meet different detection conditions, such as the above-mentioned non-speech condition and speech condition. Obviously, the adaptive method of the present invention is capable of optimizing the performance of detecting the CAS signal in a telecommunication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating operation of a prior art call waiting mechanism.

FIG. 2 is a diagram illustrating the composition of the CAS signal.

FIG. 3 is a flowchart illustrating operation of detecting a CAS signal according to an embodiment of the present invention.

### DETAILED DESCRIPTION

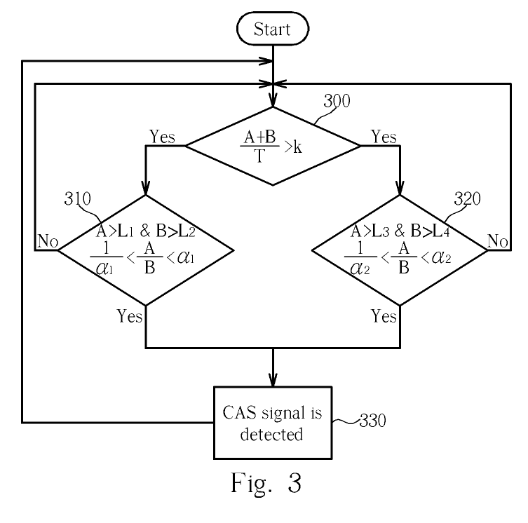

Please refer to FIG. 3, which is a flowchart illustrating operation of detecting a CAS signal according to an embodiment of the present invention. The operation of detecting the CAS signal of a telecommunication system can be summarized by: detecting a first signal energy at a first frequency; detecting a second signal energy at a second frequency; comparing a total received signal energy with a summation of at least the first signal energy and the second signal energy to generate a comparison result; and enabling a first detecting procedure or a second detecting procedure for detecting the call alert signal according to a comparison result. The method of detecting the CAS signal is detailed as follows.

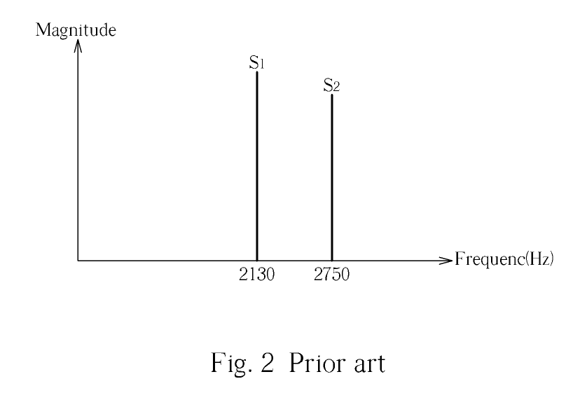

In step 300, an energy ratio ER of the summation of the first signal energy A (i.e., the energy of the DTMF signal S₁ shown in FIG. 2) and the second signal energy B (i.e., the energy of the DTMF signal S₂ shown in FIG. 2) to the total received signal energy T is determined. Then, the energy ratio ER is compared with a threshold K to generate the comparison result. If the energy ratio ER is greater than the threshold K, step 310 is performed to detect the CPE alert signal; and if the energy ratio ER is not greater than the threshold K, step 320 is performed to detect the CPE alert signal.

In step 310, the frequency energy level FL and the two-frequency energy difference TW are examined. Step 310 first compares the first signal energy A with a first frequency energy level L₁ and then compares the second signal energy B with a second frequency energy level L₂. If the first signal energy A is greater than the first frequency energy level L₁ and the second signal energy B is greater than the second frequency energy level L₂, step 310 further determines whether the CAS signal occurs in the telecommunication system. In other words, step 310 checks if the signal ratio A/B of the first signal energy A to the second signal energy B falls in a predetermined range where the limits are 1/α₁ and α₁. If the first signal energy A is greater than the first frequency energy level L₁, the second signal energy B is greater than the second frequency energy level L₂, and the signal ratio A/B falls in the predetermined range, the method of the present invention determines that the CAS signal exists (step 330). In the following, the method of the present invention goes back to step 300 for monitoring the occurrence of a next CAS signal.

In this embodiment, if either the first signal energy A is not greater than the first frequency energy level L₁ or the second signal energy B is not greater than the second frequency energy level L₂, the method of the present invention directly judges that there is no CAS signal, and then goes back to step 300 to continue monitoring the occurrence of the CAS signal. Please note that in this embodiment the first frequency energy level L₁ is equal to the second frequency energy level L₂.

In step 320, the frequency energy level FL and the two-frequency energy difference TW are examined. Step 320 first compares the first signal energy A with a third frequency energy level L₃ and then compares the second signal energy B with a fourth frequency energy level L₄. If the first signal energy A is greater than the third frequency energy level L₃ and the second signal energy B is greater than the fourth frequency energy level L₄, step 320 further determines if the CAS signal occurs in the telecommunication system. In other words, step 320 checks if the signal ratio A/B of the first signal energy A to the second signal energy B falls in a predetermined range where the limits are 1/α₂ and α₂. If the first signal energy A is greater than the third frequency energy level L₃, the second signal energy B is greater than the fourth frequency energy level L₄, and the signal ratio A/B falls in the predetermined range, the method of the present invention determines that the CAS signal exists (step 330). In the following, the method of the present invention goes back to step 300 for monitoring the occurrence of a next CAS signal.

In this embodiment, if either the first signal energy A is not greater than the third frequency energy level L₃ or the second signal energy B is not greater than the fourth frequency energy level L₄, the method of the present invention directly judges that there is no CAS signal, and then goes back to step 300 to continue monitoring the occurrence of the CAS signal.

Please note that in a preferred embodiment the first frequency energy level L₁ is equal to the second frequency energy level L₂, and the third frequency energy level L₃ is equal to the fourth frequency energy level L₄. In addition, the third frequency energy level L₃ is greater than the first frequency energy level L₁, and the second signal ratio α₂ is greater than the first signal ratio α₁. However, in other embodiments, the first frequency energy level L₁ is not limited to being equal to the second frequency energy level L₂, and the third frequency energy level L₃ is not limited to being equal to the fourth frequency energy level L₄. For example, in an alternative design, these frequency energy levels L₁, L₂, L₃, L₄ are not identical to each other, but the third frequency energy level L₃ is required to be greater than the first frequency energy level L₁, and the fourth frequency energy level L₄ is required to be greater than the second frequency energy level L₂.

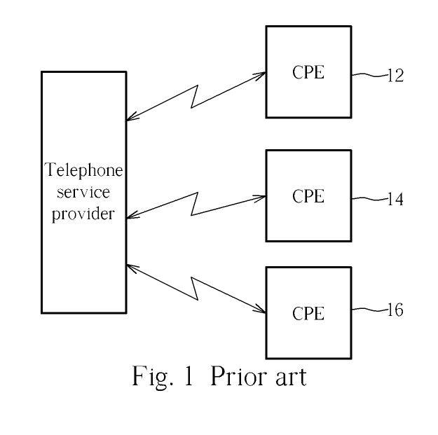

As mentioned above, using the method of the present invention, the CPE 14 shown in FIG. 1 selects one criterion out of two available criteria according to the signal-to-noise ratio (SNR). That is, step 300 is used to measure the SNR corresponding to signals at frequencies 2130 Hz and 2750 HZ. If a user of the CPE 14 shown in FIG. 1 does not talk when the telephone service provider 10 passes the CAS signal to the CPE 14, the measured SNR is sure to be high, in other words, the energy ratio ER is greater than the threshold K. Therefore, the following step 310 using higher frequency energy levels L₁, L₂ is activated to check the existence of the CAS signal. On the other hand, if a user of the CPE 14 shown in FIG. 1 talks when the telephone service provider 10 passes the CAS signal to the CPE 14, the measured SNR is sure to be low, in other words, the energy ratio ER is not greater than the threshold K. Therefore, the following step 320 using lower frequency energy levels L₃, L₄ is activated to check the existence of the CAS signal. In addition, both steps 310, 320 further check the signal ratio A/B to improve the detection accuracy.

In contrast to the prior art, the present invention can adopt different CAS detection criteria to meet different detection conditions, such as the above-mentioned non-speech condition and speech condition. Obviously, the adaptive method of the present invention is capable of optimizing the performance of detecting the CAS signal in a telecommunication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting a Customer Premises Equipment (CPE) alert signal of a telecommunication system, the method comprising:
detecting a first signal energy at a first frequency;
detecting a second signal energy at a second frequency;
comparing a total received signal energy with a summation of at least the first signal energy and the second signal energy to generate a comparison result; and
enabling a first detecting procedure or a second detecting procedure for detecting the CPE alert signal according to a comparison result.

2. The method of claim 1, wherein the step of generating the comparison result further comprises:
determining an energy ratio of the summation of at least the first signal energy and the second signal energy to the total received signal energy; and
comparing the energy ratio with a threshold to generating the comparison result.

3. The method of claim 2, wherein the step of detecting the CPE alert signal further comprises:
if the energy ratio is greater than the threshold, performing the first detecting procedure to detect the CPE alert signal; and
if the energy ratio is not greater than the threshold, performing the second detecting procedure to detect the CPE alert signal.

4. The method of claim 3, wherein the first detecting procedure comprises:
comparing the first signal energy with a first frequency energy level and comparing the second signal energy with a second frequency energy level; and
if the first signal energy is greater than the first frequency energy level and the second signal energy is greater than the second frequency energy level, determining that the CPE alert signal occurs in the telecommunication system.

5. The method of claim 4, wherein the first frequency energy level is equal to the second frequency energy level.

6. The method of claim 4, wherein the first detecting procedure further comprises:
checking if a signal ratio of the first signal energy to the second signal energy falls in a predetermined range; and
if the first signal energy is greater than the first frequency energy level, the second signal energy is greater than the second frequency energy level, and the signal ratio falls in the predetermined range, determining that the CPE alert signal occurs in the telecommunication system.

7. The method of claim 3, wherein the second detecting procedure comprises:
comparing the first signal energy with a first frequency energy level and comparing the second signal energy with a second frequency energy level; and
if the first signal energy is greater than the first frequency energy level and the second signal energy is greater than the second frequency energy level, determining that the CPE alert signal occurs in the telecommunication system.

8. The method of claim 7, wherein the first frequency energy level is equal to the second frequency energy level.

9. The method of claim 7, wherein the second detecting procedure further comprises:
checking if a signal ratio of the first signal energy to the second signal energy falls in a predetermined range; and
if the first signal energy is greater than the first frequency energy level, the second signal energy is greater than the second frequency energy level, and the signal ratio falls in the predetermined range, determining that the CPE alert signal occurs in the telecommunication system.

10. The method of claim 3, wherein the first detecting procedure comprises:
comparing the first signal energy with a first frequency energy level and comparing the second signal energy with a second frequency energy level; and
if the first signal energy is greater than the first frequency energy level and the second signal energy is greater than the second frequency energy level, determining that the CPE alert signal occurs in the telecommunication system; and
the second detecting procedure comprises:
comparing the first signal energy with a third frequency energy level and comparing the second signal energy with a fourth frequency energy level; and
if the first signal energy is greater than the third frequency energy level and the second signal energy is greater than the fourth frequency energy level, determining that the CPE alert signal occurs in the telecommunication system, wherein the third frequency energy level is greater than the first frequency energy, and the fourth frequency energy level is greater than the second frequency energy.

11. The method of claim 10, wherein the first frequency energy level is equal to the second frequency energy level, and the third frequency energy level is equal to the fourth frequency energy level.

12. The method of claim 10, wherein the first detecting procedure further comprises:
checking if a first signal ratio of the first signal energy to the second signal energy falls in a first predetermined range; and
if the first signal energy is greater than the first frequency energy level, the second signal energy is greater than the second frequency energy level, and the first signal ratio falls in the first predetermined range, determining that the CPE alert signal occurs in the telecommunication system; and
the second detecting procedure further comprises:
checking if a second signal ratio of the first signal energy to the second signal energy falls in a second predetermined range; and
if the first signal energy is greater than the third frequency energy level, the second signal energy is greater than the fourth frequency energy level, and the second signal ratio falls in the second predetermined range, determining that the CPE alert signal occurs in the telecommunication system, the first predetermined range covering the second predetermined range.
